(19) United States
(12) Patent Application Publication
(10) Pub. No.: US 2024/0262478 A1
(43) Pub. Date: Aug. 8, 2024

(54) SAIL-DRIVEN VEHICLE

(71) Applicant: COMPAGNIE GENERALE DES ETABLISSEMENTS MICHELIN, Clermont-Ferrand (FR)

(72) Inventors: OLIVIER ESSINGER, Clermont-Ferrand (FR); PIERRE-ALAIN MAGNE, Clermont-Ferrand (FR); CEDRIC SAVIO, Clermont-Ferrand (FR); BRUNO FRAGNIERE, Clermont-Ferrand (FR)

(21) Appl. No.: 18/564,757

(22) PCT Filed: May 30, 2022
(86) PCT No.: PCT/FR2022/051020

§ 371 Date: Nov. 28, 2023

(30) Foreign Application Priority Data
May 28, 2021 (FR) FR2105611

(51) Int. Cl. B63H 9/061; B63B 79/10; B63B 79/30

(52) U.S. Cl. CPC B63H 9/061; B63B 79/10; B63B 79/30

(57) ABSTRACT

A vehicle with total or partial sail propulsion comprises a hull (j), at least one sail, inflatable or not, at least one self-supporting mast (l) having a vertical axis, the mast comprising a fixed part (o) disposed at hull level and a movable part (p) that can move about the vertical axis. This vehicle is characterized in that the mast (l) comprises, in the fixed part (o), sensors for measuring physical parameters intended to supply digital data on the thrust force, the drift force, and the differential pressure of the sail, or else, in the movable part (p), sensors for measuring physical parameters intended to supply digital data on the aerodynamic thrust force projected in the axis of the sail, the aerodynamic thrust force projected in the axis at right angles to the sail, and the differential pressure of the sail.

The invention relates to a vehicle with sail propulsion and falls within the field of sail propulsion or hybrid sail propulsion.

A few definitions used in the following are reviewed hereinbelow:
Rigging: set of fixed and movable parts of a boat, of sail type, allowing the propulsion and the maneuvering thereof by the force of the wind.
Lean: transverse inclination of a ship caused by a phenomenon, external or not.
Hydrodynamic drag: friction force between the boat and the water. The higher the drag, the more the boat is slowed down.
Aerodynamic drag: component of the force undergone by a body in motion in a fluid which is exerted in the direction opposite to the direction of the motion. According to the invention, the sail generates an aerodynamic drag.
Aerodynamic lift: component of the force undergone by a body in motion in a fluid which is exerted at right angles to the direction of the motion. According to the invention, the sail generates an aerodynamic lift.
Relative wind or apparent wind: vector sum of the wind created by the inherent speed of the boat and the real speed of the wind.
Aerodynamic resultant: vector sum of the aerodynamic lift and of the aerodynamic drag.
Polar curve: graphic representation expressing the speed of a boat as a function of the direction and of the force of the wind. A polar curve makes it possible to establish navigation scenarios. In some cases, it can also be as a function of the differential inflation pressure of the sail (sail that can also be called wing when the sail is of inflatable type and at a certain value of the pressure inside the latter).
Wind incidence angle: angle between the plane of the profile of a sail (or of a wing when the sail is of the inflatable type at a certain value of the pressure inside the latter) and the relative wind direction.
Open-loop control system, also called system without return: in an open-loop system, the desired output does not depend on the control action; the output of the system is free of the input; in regulation, an open-loop control system is a form of control which does not take account of the response of the system.
Closed-loop control system, also called system with return: in a closed-loop system, the desired output depends on the control action of the system, and therefore on the input. Although more complex, a closed-loop control system is more reliable, accurate and stable; it allows for an optimization of the results expected at the output by the measurement of its output values and the comparison with the setpoint values; in regulation, a closed-loop control system is a system which incorporates the reaction of this system.
Reefing: consists in reducing the surface area of a sail by partly folding it from the bottom, in order to adapt the surface area of the sail to the force of the wind. The reefing can be done manually or automatically.
Reefing bands: horizontal zones in reinforced parts making it possible to fix the returns for reefing, with, for example, eyelets or pulleys. These reefing bands are disposed on the sail at rib level at each height where reefing is planned. There are as many reefing bands as there are possibilities for reducing the sail area.
Boom: horizontal spar, articulated close to the base of the mast, and which makes it possible to hold and orient some sails. The boom can also receive the sail when the latter is lowered.
Luff: a sail which luffs is a sail that is insufficiently hauled in which is partly deflated. A well set sail should be at the luffing limit. With an inflated sail, there is no luffing, which makes it possible to remain facing the wind.
Head: top end of the sail which follows the top contour of the inflatable sail.
Lowering: consists in lowering the sail.
Hoisting: consists in raising the sail.
Sail receptacle: in addition to receiving the lowered sail, it can incorporate other functions, such as taking up the tensile efforts supplied by the sail, or else housing other actuators, sensors, energy storage and control module that are used to operate the sail.

### PRIOR ART

Already known is ship propulsion by heat engine for which it is easy to measure the fuel consumption, and thus deduce therefrom the quantity of carbon gas emitted.

Such a measurement on a ship with sail propulsion is more difficult, because it is complex and somewhat random.

The document CN 107878720A discloses a sail of a sailboat, of symmetrical profile and flexible and that can be folded down. Such a sailboat is equipped with a hydraulic device for measuring the angle and the force of the relative wind. These data are acquired permanently by a computer provided with an algorithm calculating the data according to an open-loop control system, in order to regulate the behaviour of the sail with respect to the angle and the force of the wind.

Unfortunately, such a device, which operates according to an open-loop system only, does not take account of all the factors influencing the value of the aerodynamic thrust. In particular, this model does not incorporate the changing polars as a function of the sea state, of the strong wind variations, of the imperfections of the modelling of the wing (polar curve) or of the degradation of the performance levels of the sail in time.

Furthermore, with such a system, it remains difficult to measure the thrust, the power or the energy supplied by the sail propulsion since this system does not include a sensor of the effort that the wing provides to the ship.

### SUMMARY OF THE INVENTION

So, there remains the need to have a system capable of regulating the sail thrust, in order to optimize it and also make it possible to quantify accurately, reliably and directly, the aerodynamic thrust transmitted by the sail to the hull of a ship, comprising at least one sail, and, possibly, a hybrid system, in order to save on fuel and therefore reduce the carbon gas emissions.

The subject of the invention is a vehicle with total or partial sail propulsion comprising a hull, at least one inflatable sail (or wing) or a non-inflatable sail, but one which is supported by a mast so as not to be guyed, at least one self-supporting mast with a vertical axis, said mast comprising a fixed part disposed at hull level and a movable part that can move about the vertical axis.

The vehicle according to the invention is characterized in that said mast comprises either, in the fixed part, sensors for measuring physical parameters intended to supply digital data on the thrust force in the axis of the boat, the drift force of the boat, the differential pressure of the sail for an inflatable sail (or of the wing for an inflatable vertical wing), or, in the movable part, sensors for measuring physical parameters intended to supply digital data on the aerodynamic thrust force projected in the axis of the sail (or in the axis of the wing), the aerodynamic thrust force projected in the axis at right angles to the wing (or to the sail), the differential pressure of the sail for an inflatable sail (wing).

The solution of the invention can be applied to vehicles with sail propulsion comprising inflatable or non-inflatable sails, to taut sails, to rigid sails supported unguyed by a mast or to sails mounted on a self-supporting mast.

According to the invention, the sensors incorporated in the fixed part with respect to the reference frame of the boat, for example in the fixed part receiving the elements for rotating the mast, make it possible to reliably and directly measure the efforts transmitted to the boat and to directly know the efforts in the axis of the boat (efforts used for the propulsion) and the efforts at right angles to the axis of the boat (efforts which provoke the lean of the boat). For this, it is for example possible to equip one of the bearings receiving the base of the mast (understood to be for the support and rotational guidance of the mast) with strain gauges, which makes it possible to have a direct measurement of the efforts. When the mast is telescopic, preference is given to equipping one of the bearings which ensures the support and rotational guidance of the bottom tube of the mast with strain gauges.

When it is not on the fixed part, the measurement system can comprise measurement sensors fixed onto the mast, for example by adhesively bonding strain gauges to it, which makes it possible to know the efforts in the axis of the sail (or of the wing when it is an inflated sail) and the efforts which are at right angles to it. It is in this case necessary to have an accurate measurement of the angle of the wing with respect to the axis of the boat (efforts used for the propulsion) and of the efforts at right angles to the boat (which provoke the lean of the boat).

The values derived from the direct (boat reference frame) or indirect (wing reference frame) measurement of the efforts already make it possible to accurately evaluate the gains obtained with the sail propulsion system.

The measured values also offer the possibility of modifying the operation of the ship by using an open-loop regulation and/or a closed-loop regulation.

Thus, in open-loop mode, the measured values of the efforts are used for monitoring when the boat is moving so as not to exceed pre-established limit values of the measured efforts.

Preferably, a computer equipped with a digital data computation algorithm calculates, according to an open-loop control system, and based on said digital data, such as the speed and the direction of the wind, the setting values, such as the desired differential pressure, incidence angle and wing surface area settings. If, in this open-loop mode of operation, the incidence angle, wing surface area and pressure settings lead to excessive efforts, exceeding pre-established limits, the system receives an alert originating from the effort sensors so as to be able to act to reduce these efforts.

Preferably, a computer, equipped with a digital data computation algorithm, calculates, according to a closed-loop control system, based on said digital data, the forces transmitted from the sail to the hull in order to modify in real time the operation of the ship to optimize or finely regulate the aerodynamic thrust thereof. The computer uses the measured thrust value to try to regulate it (to a chosen value below the maximum thrust) or optimize it (search for the maximum thrust) and therefore maximize the energy saving.

It thus makes it possible to perform an optimization of the maximum thrust transmitted to the ship by the sail propulsion system, based on a closed-loop regulation working directly on the maximization of the thrust, and therefore of the gains.

The vehicle according to the invention offers the advantages of being able to easily and in real time follow the changes of the system and consequently the drift thereof with respect to the initial values, and to take account of this change in the optimization of the thrust, and therefore allow the programming of maintenance operations, and, finally, as for example in the inflated sail case (such as that of the document WO 2017/221117A1), to visualize the change of its pressure for a given action of the inflation system, and thus follow the change of permeability thereof. Indeed, in closed-loop mode, the system tracks the maximum effort or the setpoint effort and makes it possible to overcome the polar curve modelling errors. If, over time, for the same conditions of wind, of inflation pressure, the operating point (incidence angle) found by the closed-loop regulation system changes, it is because the system has changed. It has certainly become degraded and a maintenance intervention can be planned.

The regulation system of the vehicle with sail propulsion of the invention can operate with both loops: open and closed in combination when everything is operational. The open loop makes it possible to preposition the wing in order to produce the desired effort by setting an incidence angle, a wing surface area and a differential pressure that are based on modelling tables. The closed loop refines these settings in order to optimize the thrust by being based (in feedback mode) on the measurement of the thrust effort.

However, following the failures encountered, the system can operate in degraded mode with only one of the two regulation loops (open or closed).

The vehicle according to the invention makes it possible to specify the gains obtained with the sail propulsion system.

The vehicle according to the invention makes it possible to accurately and measurably quantify the sail propulsion force in the axis of the boat, which, combined with the boat speed, will provide the kWh supplied, the kWh consumed, and the CO2 gains.

A hybrid propulsion vehicle according to the invention is understood to mean sail propulsion coupled with another propulsion source such as, for example, propulsion by a propeller, driven by an electric motor or combustion engine, with, as energy storage, batteries, hydrogen (with a fuel cell), natural gas or fuel.

A sail propulsion vehicle is understood for example to mean sand yachts, ice yachts, cars, boats as long as the link between the sail and the vehicle is produced in an unguyed manner with a self-supporting mast system.

### DESCRIPTION OF THE DRAWINGS

The invention will be described using the following figures given by way of illustration, that are schematic and not necessarily to scale, and in which:

FIG. 1 represents a review of the various physical forces which are applied to a ship, for example of sail type with an engine, and notably the projection of the resultant aerodynamic force;

FIG. 2 represents a schematic view of the system for controlling the thrust in closed-loop mode used by the algorithm in the ship according to the invention in the case of an inflated sail;

FIG. 3 represents a schematic view of the open-loop control system used by the algorithm in the ship according to the invention in the case of an inflated sail;

FIG. 4 represents a schematic view of the closed-loop control system combined with the open-loop control system used by the algorithm in the ship according to the invention in the case of an inflated sail.

A review of some hydrodynamic and aerodynamic definitions concerning sail propulsion is set out hereinbelow.

A vehicle with sail propulsion, hereinafter called sailboat or ship, is in contact with the air and with the water. On the physical plane, the predominant factors are the hydrodynamic and aerodynamic forces which are exerted on the hull, the sails and the appendages (rudders, keel, helm), propeller.

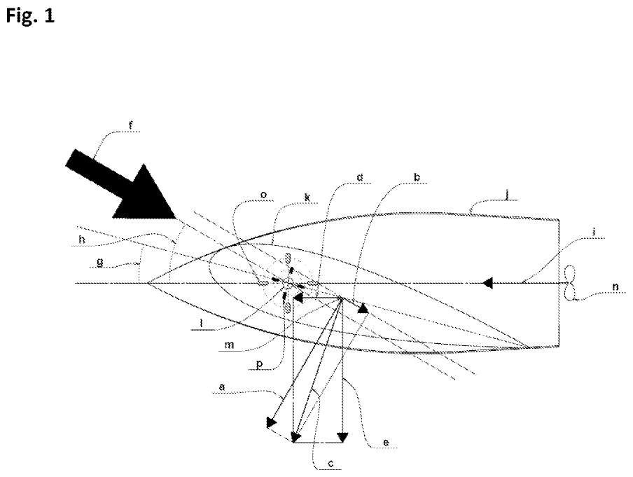

As FIG. 1 shows, the aerodynamic force (or sail thrust) results from the deflection of the air by at least one sail. The aerodynamic force is relative to the position and the surface area of the sail and to the position and the force of the relative wind. The drag force is in the direction of the relative wind, the lift force is in the direction at right angles to the relative wind, it is not always at right angles to the sail. For example, at 0°, a symmetrical profile has no lift due to the fact that the air travels strictly the same distance on the upper surface and the lower surface. At this moment, it generates only drag.

The aerodynamic force generated by the sail can also be broken down in the reference frame of the boat, and not in that of the sail, to be composed of the sail propulsive force (which is in the axis of advance of the boat) and into a drift force (at right angles to the axis of the boat) which can induce lean (transverse inclination of a boat caused by an external phenomenon such as the wind).

The hydrodynamic force results from the friction of the water on the hull and the rudder or keel and the various submerged appendages. Its direction depends on the aerodynamic force which it opposes, on the propulsive force in hybrid mode, on the state of the sea and on the ocean currents. The longitudinal component is called hydrodynamic drag, and the transverse component is called rudder lift or anti-drift force or hydrodynamic lift. The direction and the intensity of the hydrodynamic force does not depend only on the aerodynamic force. For a vessel (boat) operating in hybrid mode (wind and other energy), the hydrodynamic force will depend greatly on the speed of the vessel, generated by the heat or electrical propulsion for example, on the state of the sea and on the ocean currents.

When the sail force is greater than the hydrodynamic force, the boat speeds up. When the sail force is less than the hydrodynamic force, the boat slows down. Furthermore, if the aerodynamic force is greater but directed towards the rear of the boat, the latter will slow down. If the hydrodynamic force is in the direction of advance of the boat (because there is a strong current), the boat (sailboat) will speed up.

It is by optimizing the setting of the sail that the boat (sailboat) will achieve its maximum performance in terms of sail thrust in the direction of advance. Indeed, it is the optimization of the angle of the sail with respect to the relative wind and to the direction of the boat, as well as the setting of the surface area of the sail which will allow the boat to achieve the maximum sail propulsion thereof in the axis of the boat. There can be an additional setting parameter by acting on the internal pressure of the sail. This thus makes it possible to increase the speed of the boat or, on the contrary, to maintain the same speed while reducing the consumption of other energies, in favour of the sail propulsion.

FIG. 1 again uses each of the preceding designations, with a reference which is specific to it listed hereinbelow:
a: Lift force
b: Drag force
c: Aerodynamic resultant force
d: Aerodynamic thrust force (in the axis of the ship)
e: Aerodynamic drift force
f: Relative wind
g: Wing—boat axis relative angle (e.g.: 15°)
h: Relative wind and boat axis angle (e.g.: 30°)
i. Propeller propulsive force
j: Hull
k: Sail
l: Mast
m: Centre of aerodynamic thrust
n: Propeller
o: Sensor on fixed part (hull reference frame)
p: Sensor on movable part (sail reference frame)
   The information given in FIG. 1 makes it possible to pass values measured in the hull reference frame to the sensors of data originating from the sail reference frame, and vice versa.

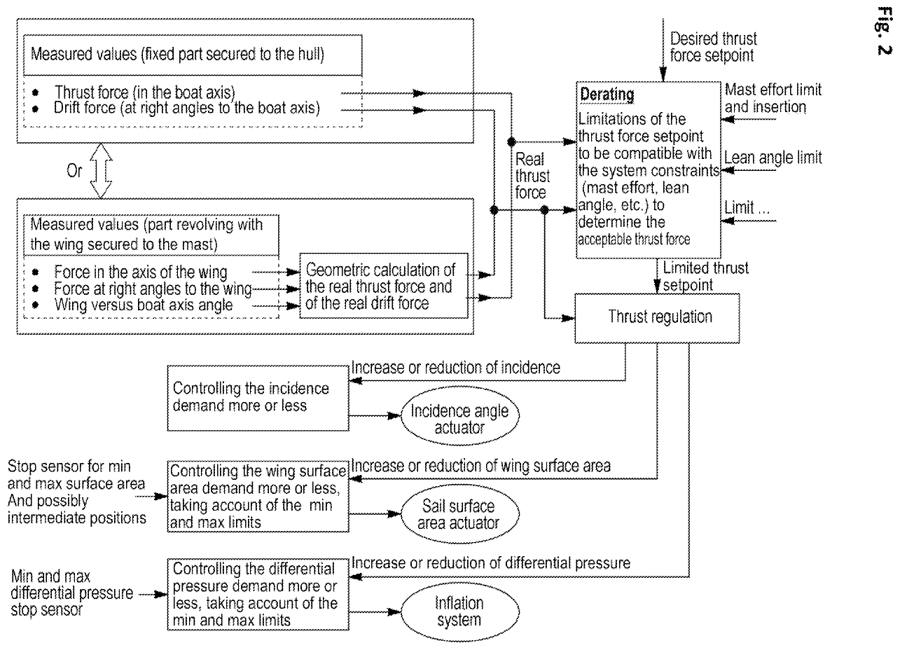

As FIG. 2 shows, the closed-loop control system used in the subject of the invention comprises various steps of calculations on the basis of the measured input data. The purpose of the control system used according to the invention is to either achieve a setpoint value of the thrust force if achievable, corresponding to a throttle control for example, or to go to the maximum value of the thrust force in the axis of the ship.

This control system must also take account of intrinsic limitations of the system such as the acceptable maximum force on the mast, the maximum pressure difference acceptable for an inflated sail, or even constraints linked to the ship, such as the maximum acceptable lean angle for example.

The use of the closed-loop control system, with the sensors directly in the reference frame of the hull, directly measures the value set, namely the thrust in the axis of the ship, without needing to obtain it through a calculation based on estimated values. Another solution is to measure the thrust in the reference frame of the sail, that is to say in the axis of the sail and in the axis at right angles to the sail. It will then be necessary to know the angle of the sail with respect to the ship, so as to bring the forces into the axis of the sail and at right angles to the sail (reference frame of the sail) back into thrust force and drift force in the reference frame of the ship. As for the regulation of the pressure difference between the outside and the inside of the sail, in the case of an inflatable sail, this pressure difference can be measured by a differential pressure sensor and set by a set pressure difference setpoint, i.e. servo controlled by taking account for example of the force and direction of the wind, of the variations of force and direction of the wind (ratio between max value and min value), on the state of the sea for example. The inflation system can for example be produced with fans. Fans are regulated in order to achieve the pressure difference setpoint between the inside and the outside of the wing.

By using a closed-loop control or regulation system allows an optimization of the efforts and, using the values supplied by the effort sensors, quantification of the gain in lowering CO₂ emission.

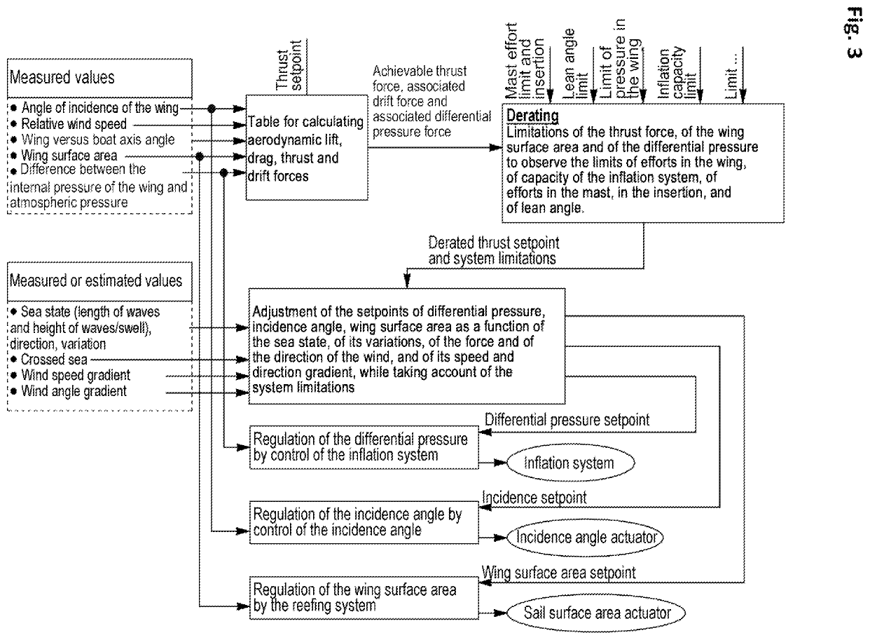

As FIG. 3 shows, the computation algorithm with which the ship according to the invention is equipped can calculate an incidence angle setpoint of the wing (or inflatable sail), a wing (or inflatable sail) surface area setpoint and a wing (or inflatable sail) differential pressure setpoint, according to an open-loop control system, based on conversion tables for example, for a desired thrust value. These setting values (incidence angle setpoint of the wing, a wing surface area setpoint and a wing differential pressure setpoint) remain the same, if for example the wing were torn or damaged, because it does not involve a measurement of the result.

In an open-loop control system, it is possible to act on the regulation of the pressure for example, in the case of an inflatable sail, by regulating a speed of rotation of the fans, which will correspond to a certain pressure difference (speed-pressure equivalence table) for the pressure difference between the inside of the sail and the outside. If the fan is mounted without propeller, the pressure will not be good, and it will not be seen. There are nevertheless other means that make it possible to check this kind of problem, such as, for example, monitoring of the engine current associated with a certain speed.

The advantage of the open-loop control system is that it makes it possible to know a priori the values to be set in the system to obtain a certain thrust. It also makes it possible to dispense with the effort measurement sensors. The regulation of the thrust is, by contrast, less accurate, and if the initial estimations are poor, it will not be known, and likewise if the performance levels are degraded in time since there will not be the physical reaction of the system through the force sensors for example.

If only the open-loop regulation is used, it will be possible to operate without having the possibility of reupdating the conversion table (polar curve), and probably with an approximation error, but that nevertheless makes it possible to operate.

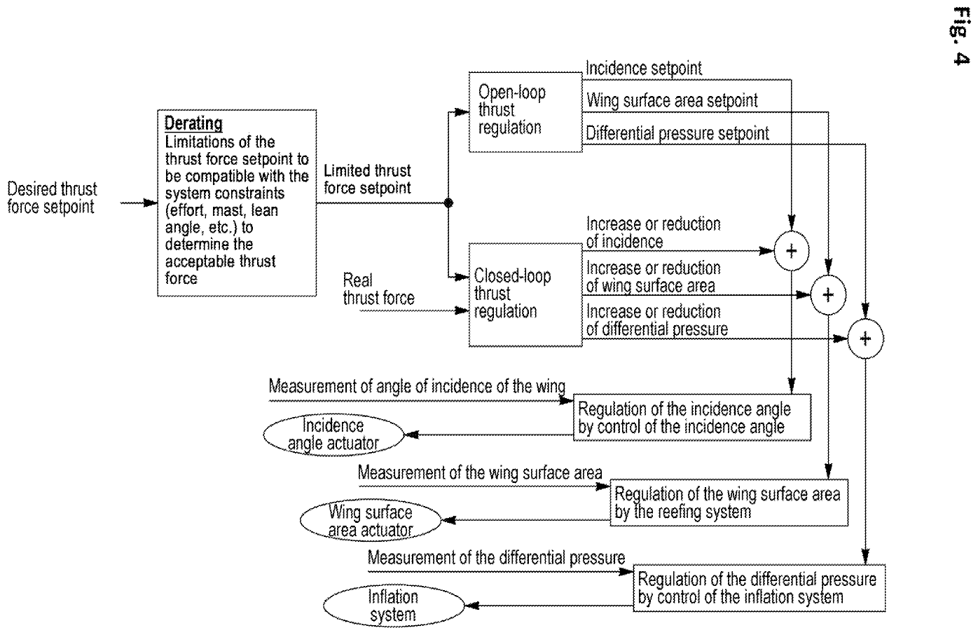

However, as FIG. 4 shows, the algorithm used by the computer of the ship according to the invention can combine the closed-loop control system and the open-loop control system.

The use of the two control systems makes it possible to use the measured values of the closed loop to reupdate the tables of estimated values of the open loop. The change of this conversion table (polar curve) will make it possible to have an idea of change of the performance of the sail, either more (run-in), or less (wear). That can be very useful for preventive maintenance. The two systems can be totally independent at the measurement level. By actuators, that can be of particular interest for safety, reliability and availability reasons.

Finally, the regulation that uses only the measurement sensors in the hull (mast support), in case of failure of the wind vane used to measure the speed and the direction of the wind, can operate autonomously in the following ways.

Firstly, by freeing the rotation of the sail, the system sets its face to the relative wind, and the sail is used as wind vane. That is possible by virtue of the offsetting of the mast versus centre of thrust (self-alignment of the wing in the wind).

Secondly, it is then possible to hoist the sail to a certain height corresponding to an acceptable drag value. The measurement of the drag of the sail makes it possible to assess the force of the wind, which makes it possible to determine the necessary sail surface area.

Finally, the thrust optimum or the setpoint value can then be achieved, by taking account of the limitations of the system, such as the maximum lean efforts for example.

Thus, it is perfectly possible to use a closed-loop control system alone in case of failure of the wind vane necessary to the closed loop, rendering the latter inoperative. The combined use of the two independent systems makes it possible to increase the reliability of the response obtained, the availability and the safety.

It is also possible to alternately use one or other of these control systems with the possibility of measuring the change of the responses obtained.

These control systems operate as follows.

In a first stage, the polars of the sail are used for the calculations. The polars supply, for different wind speeds and incidence angles, different sail surface areas (total or reduced by one, two or three reefs), and possibly different differential pressures, the lift and drag values of the sail that can be achieved. Based on these data, the aerodynamic resultant force is calculated.

Through the vector sum of the lift force and of the aerodynamic drag force, the resultant aerodynamic force is obtained.

It is then necessary to switch from the reference frame of the sail to the reference frame of the ship so as to obtain the forces of aerodynamic thrust in the axis of the boat, and of drift at right angles to the axis of the boat (the latter provoking the lean of the ship). To switch from one reference frame to the other, it is necessary to have the angle of incidence of the sail and the angle of the sail with respect to the axis of the ship.

In the following description, the operation of the sail in normal mode and in a mode including a malfunction is detailed.

### Example of Normal Mode:

Initially, the sail is folded in the receptacle of the sail, with the mast, if it is telescopic, in the folded position. The receptacle of the sail can be closed on the top automatically or manually so as to protect the fabric of the sail from the attacks from UV, moisture, wind, salt, etc. The sail is blocked in rotation, and positioned in the axis of the ship. The electronic power controls are stopped.

Next, the electronic controls are powered up and controlled. If everything is correct, the top part of the sail receptacle is opened manually or automatically. The rotation of the sail is also unblocked (exit from the parking mode) manually or automatically. The sail is ready to operate.

The hoisting of the sail is performed as follows.

In this hoisting phase, the system operates normally (without failure) in open loop mode. The force and the direction of the relative wind, the angle of the sail with respect to the boat, the pressure inside the sail, and consequently the expected thrust and drift forces, are a priori known. With these data, the settings to be set on the sail will be defined a priori. The sail will therefore be hoisted by positioning it facing the wind, and deployed fully, or by keeping reefs according to the calculations, with a targeted incidence angle, which will be reupdated as a function of the measurements of relative wind force and speed, of angle of the wing with respect to the boat and of internal pressure of the wing, and of the targeted thrust setpoint.

In case of failure of an element of the open loop preventing the latter from operating and, in the case of a wind vane failure explained above, the hoisting can, in a degraded mode, be performed by using the closed-loop regulation. Discovery will be made as the sail is hoisted. The first step consists in setting the sail face to the relative wind, which can be done by leaving free the control of the incidence angle of the sail with respect to the boat. The sail or the sail receptacle are used as a wind vane, by virtue of the fact that the centre of aerodynamic thrust is offset with respect to the axis of the mast. The system is set automatically face to the wind by itself, and, from that, the direction of the wind is known. As for the force of the wind, it is possible to have a first assessment by observing the speed of displacement of the sail, to revert face to the wind. All that is needed is to offset it by 10° and to watch the speed with which it reverts face to the wind. That will give a first idea concerning the sail surface area which will be necessary. It is also possible to assess it by measuring the drag of the sail. It is then necessary to mount the sail while leaving it face to the wind, to its smallest surface area, corresponding for example to the third reef. If the efforts do not exceed the limitations by setting it to the maximum thrust, it is possible to free an additional reef, for example to free the third reef. If the efforts again do not exceed the limitations, it is possible to again increase the sail surface area, this being able to go as far as deploying the complete surface area of the sail. During the hoisting phase, the sail is left free to rotate so as to be positioned face to the wind. The only moment at which the angle will be controlled will be at each new surface area (reef 1, reef 2, etc.) to produce the thrust efforts. During the hoisting, the internal pressure of the sail is set, and the raising speed also in order to guarantee optimal operation while minimizing the ageing of the wing (luffing).

In open and/or closed loop mode, the setting is known a priori by virtue of the open loop, but with an ongoing verification of the consistency of the projected values with the measured values (closed loop) and updates in real time of the computation models.

The sail operates as follows.

When the sail is in operation, the setting will be constantly optimized or regulated so as to correspond to the setpoint value demanded by taking account of the limitations, or else to have the maximum thrust by taking account of the limitations.

This setting will be done mostly by using the closed-loop regulation, which will make it possible to best optimize the thrust by taking account of the limitations. However, the a priori setting of the open loop based on the polar curves makes it possible to position the wing close to the optimum, leaving the regulators of the closed loop to refine the operating point in order to achieve the desired or maximum thrust. Also, when the wind changes direction very rapidly (switching of the wind, transit from wind from the north to wind from the south), the closed-loop regulation can momentarily be stopped in order to rapidly reposition the wing close to the new optimum then to reactivate the closed-loop regulation. Beyond the measured values, it is also possible to use the wind forecasts, or else the values measured by the beacons or the other boats, to make an a priori setting. During the phase of sail in operation, the thrust is optimized, but the other values such as the drift for example are observed also, so as not to exceed the imposed limitations. If these values were to be exceeded, it is possible to limit them by acting on the incidence angle, or else by reducing the sail surface area (see reefing). Conversely, if the values are too low, and there are still one or more reefs to be let go, it has to be done while continuing to monitor the thrust and drift forces.

It is important to understand that a certain thrust can be obtained with settings which may be different. It is for example possible to obtain a lower thrust by changing the incidence angle of the sail, or by reducing the surface area of the sail.

The advantage of acting on the angle and that it is a fast operation that requires little energy. When the wind is changing for example, this is the manoeuvre to be used.

It may also be very advantageous to reduce the sail surface area by reefing, so as to simultaneously reduce the surface area of the sail and the height of the centre of aerodynamic thrust. This operation will make it possible, once reefed, to reduce the drift effort, so as to remain within acceptable drift values and, if necessary, reef again, or completely lower the wing (or the sail).

To lower the sail, the same operation as that of reefing is used.

Once the sail is lowered, it is possible to place it in the axis of the boat in order to manually or automatically lock the rotation of the sail. It then has to be protected from external attacks by manually or automatically reclosing the top part of the sail receptacle. The electronic control and power systems can then be shut down.

Upon malfunction, various situations can occur. Some of them are explained hereinbelow:

Power supply completely cut with the sail in operation: in this case, the sail steering motor (incidence) is set free to rotate, and the sail will be feathered face to the wind. The fans are shut down, but the dynamic air intake continues to supply the sail with a sufficient pressure which prevents the wing from luffing. The sail will remain thus, with the sail surface in position, the sail remaining permanently face to the wind (minimization of the efforts).

Fault of the open regulation loop sensors and essentially wind speed and direction: the closed regulation loop takes over on its own.

Fault of the sensors of the closed regulation loop: the open regulation loop takes over on its own.

Malfunctioning of both regulation loops: leave the sail to come itself face to the wind, which minimizes the efforts on it. That amounts to being the same as completely cutting the electrical power supply of the sail, except if the fans can still be actuated without any danger. A separate emergency power supply of the fans can be used.

### Loss of Actuators:

Loss of the fans: As there are several fans, it should be possible to power them separately so as not to lose all of them. However, that can nevertheless occur. In this case, the dynamic inflation of the sail will prevent it from luffing and allow the sail to be lowered without risk, until the fans are repaired.

Loss of the actuators used for hoisting or lowering the sail: If it is possible to lower but not hoist, this is not a problem. It is sufficient to lower the wing to make it safe.

Conversely, if it is not possible to lower, that will depend on what is blocked. If, for example, the sail guidance line is no longer operating, it will still be possible to lower, but that will require a manual intervention so as to stow the wing correctly. The same applies if a reefing no longer operates. However, if the mast no longer lowers, there is a manual solution to actuate the motor. By contrast, if it is the pipes which are seized, it is possible that one or two elements no longer retract. It will then be possible to haul in all the other elements so as to intervene on the blocked elements at an acceptable height.

If the mast remains truly blocked when completely deployed, it is possible to leave the sail face to the wind so as to minimize the efforts.

Loss of the actuator setting the angle of the sail: In the event of loss of the control of the mast angle actuator, the incidence system is automatically set to free mode, which provokes the feathering of the sail face to the wind. It could however be that the actuator is blocked, and that then the sail is located at a fixed angle, which could be hazardous depending on the wind conditions. If it is possible to go with the boat to an angle which means that the sail is face to the wind, that makes it possible to lower the sail. The case of all sailboats with conventional sails then applies, in which the large sail must be hoisted or lowered while face to the wind. The other solution in the case where it is not possible or not desirable to divert the ship from its route, it is possible to have a manual disconnection system, or even a fusible element in the effort transmission chain, which will free the sail to allow it to go face to the wind.

### Example 1

The CO₂ gains can go from 100% of the consumption of the ship (in the case where there is a switch to an entirely sail propulsion mode such as NEOLINE) to 0% if the wind is head-on and the sail must be lowered because there is no lift and, in addition, otherwise drag is generated. This is still better than a rotor solution which cannot be folded down and which will slow down. The situation will become negative.

For an average gain value, 10 to 15% will be banked on depending on the routes.

### Example 2

For a ship having the following dimensions:
Boat length: 16 metres
Sail height: 38 metres
Height of the hull and of the sail: 41.5 metres
Hull height: 3.5 metres

The following results are obtained:

| Incidence | Lift coefficient | Propulsive force | Propulsive force |
|---|---|---|---|
| angle | Cz | 13 kts | 20 kts |
| 5° | 0.54 | 13 500N (91 kW) | 17 500N (175 kW) |
| 8° | 0.86 | 21 700N (145 kW) | 27 300N (280 kW) |

The wind propulsive force in the axis of the boat will vary among other things according to the force and the direction of the real wind, the speed of the boat, the incidence angle of the wing, the number of sails, the sail profile and the surface area of the sails.

In order to have an order of magnitude, a wind of 15 knots is assumed, situated at right angles to the boat. The sail concerned will be a single sail of approximately 500 m².
The incidence angle of the sail will be supplied for a value of 8°.
The speed of the boat itself also has a significant influence, the efforts will be observed for boat speeds of 20 knots.
With the conditions described above, the propulsive force for a boat speed of 20 knots, with a real wind of 15 knots forming an angle of 90° with respect to the route of the boat, the incidence angle of the sail being approximately 8°, the propulsive force in the axis of the boat for a single wing of 500 m² will be of the order of 27 kN, i.e. a supplied power of approximately 280 kW. With four sails in these conditions, the power supplied is above a MW.
Regarding the drift thrust value, it will vary depending on the pace chosen in an order of magnitude ranging from 0 to approximately 75% of the thrust in the axis of the boat.

1.-3. (canceled)

4. A vehicle with total or partial sail propulsion comprising a hull (j), at least one sail, inflatable or not, at least one self-supporting mast (l) having a vertical axis, the mast comprising a fixed part (o) disposed at hull level and a movable part (p) that can move about the vertical axis, wherein the mast comprises:
(a) in the fixed part (o), sensors for measuring physical parameters intended to supply digital data on thrust force, drift force, and differential pressure of the sail for an inflatable sail, or
(b) in the movable part (p), sensors for measuring physical parameters intended to supply digital data on aerodynamic thrust force projected in the vertical axis of the sail, aerodynamic thrust force projected in the vertical axis at right angles to the sail, and differential pressure of the sail for an inflatable sail.

5. The vehicle according to claim 4 further comprising a computer, equipped with a digital data computation algorithm, wherein the computer calculates, according to a closed-loop control system, based on the digital data, forces transmitted from the sail to the hull in order to modify in real time operation of the ship to optimize or regulate aerodynamic thrust.

6. The vehicle according to claim 5, wherein the computer calculates, as a complement to the closed-loop control system, according to an open-loop control system, and based on the digital data, forces transmitted from the sail to the hull in order to modify in real time operation of the ship to optimize aerodynamic thrust.
